(19) United States
(12) Patent Application Publication
(10) Pub. No.: US 2024/0098441 A1
(43) Pub. Date: Mar. 21, 2024

(54) LOW FREQUENCY AUTOMATICALLY CALIBRATING SOUND SYSTEM

(71) Applicant: HARMAN INTERNATIONAL INDUSTRIES, INCORPORATED, Stamford, CT (US)

(72) Inventors: Todd S. WELTI, Thousand Oaks, CA (US); Kevin SHANK, Canoga Park, CA (US)

(73) Assignee: HARMAN INTERNATIONAL INDUSTRIES, INCORPORATED, Stamford, CT (US)

(21) Appl. No.: 18/272,467

(22) PCT Filed: Jan. 15, 2021
(86) PCT No.: PCT/US2021/013586

§ 371 Date: Jul. 14, 2023

(51) Int. Cl. H04S 7/00

(52) U.S. Cl. CPC H04S 7/301; H04S 7/303; H04S 2400/15

(57) ABSTRACT

An audio system is provided with at least two low frequency transducers to project sound within a room and a portable device with at least two microphones to receive sound at the first listening location from multiple directions. A microcontroller is programmed to provide a calibration command in response to a user input, and to provide a measurement signal indicative of the sound received by the microphone array. A processor is programmed to provide a test signal in response to receiving the calibration command, wherein each low frequency transducer is adapted to generate a test sound in response to the test signal. The processor is further programmed to: process the measurement signal to predict a sound response at a second listening location adjacent to the first listening location, and adjust a sound setting associated with each low frequency transducer to optimize sound at the first and second listening locations.

### TECHNICAL FIELD

The present disclosure is directed a system and method for automatically calibrating a sound system.

### BACKGROUND

Sound systems typically include loudspeakers that transform electrical signals into acoustic signals. The loudspeakers may include one or more transducers that produce a range of acoustic signals, such as high, mid and low frequency signals. One type of loudspeaker is a subwoofer that may include a low frequency transducer to produce low frequency signals.

The sound systems may generate the acoustic signals in a variety of listening environments, such as home listening rooms, home theaters, movie theaters, concert halls, vehicle interiors, recording studios, and the like. A listening environment includes multiple listening positions for a person or persons to hear the acoustic signals generated by the loudspeakers. e.g., different sections of a couch within a home listening room.

The listening environment may affect the acoustic signals, including the low, mid, and/or high frequency signals at the listening positions. Depending on where a listener is positioned in a room, the loudness of the sound can vary for different tones. This may especially be true for low frequencies in small rooms in a home because the loudness (measured by amplitude) of a particular tone or frequency may be artificially increased or decreased. Low frequencies may be important to the enjoyment of music, movies, and most other forms of audio entertainment. In the home theater example, the room boundaries, including the walls, draperies, furniture, furnishings, and the like may affect the acoustic signals as they travel from the loudspeakers to the listening positions.

The acoustic signals received at the listening positions may be measured. One measure of the acoustical signals is a transfer function that may measure aspects of the acoustical signals including the amplitude and/or phase at a single frequency, a discrete number of frequencies, or a range of frequencies. The transfer function may measure frequencies in various ranges. The amplitude of the transfer function is related to the loudness of a sound. Generally, the amplitude of a single frequency or a range of frequencies is measured in decibels (dB). Amplitude deviations may be expressed as positive or negative decibel values in relation to a designated target value. When amplitude deviations are considered at more than one frequency, the target curve may be flat or of any shape. A relative amplitude response is a measurement of the amplitude deviation at one or more frequencies from the target value at those frequencies. The closer the amplitude values measured at a listening position correspond to the target values, the better the amplitude response. Deviations from the target reflect changes that occur in the acoustic signal as it interacts with room boundaries. Peaks represent an increased amplitude deviation from the target, while dips represent a decreased amplitude deviation from the target.

These deviations in the amplitude response may depend on the frequency of the acoustic signal reproduced at the subwoofer, the subwoofer location, and the listener position. A listener may not hear low frequencies as they were recorded on the recording medium, such as a soundtrack or movie, but instead as they were distorted by the room boundaries. Thus, the room can change the acoustic signal that was reproduced by the subwoofer and adversely affect the frequency response performance, including the low frequency performance, of the sound system.

Many techniques attempt to reduce or remove amplitude deviations at a single listening position. Additional techniques attempt to reduce or remove amplitude deviations at multiple listening positions, for example, U.S. Pat. No. 7,526,093 to Devantier et. al, which is assigned to Harman International Industries Inc., discloses a system for configuring an audio system using a sound field measurement approach that includes taking a sound measurement from each subwoofer position and from each listening location. Removing amplitude deviations at multiple different listening positions is more difficult, and generally relies on using multiple sources at different locations in the room.

### SUMMARY

In one embodiment, an audio system is provided with at least two low frequency transducer to project sound within a room and a portable device. The portable device includes a microphone array comprising at least two microphones to receive sound at the first listening location from multiple directions. A microcontroller is programmed to provide a calibration command in response to a user input, and to provide a measurement signal indicative of the sound received by the microphone array. A processor is programmed to provide a test signal to each low frequency transducer in response to receiving the calibration command, wherein each low frequency transducer is adapted to generate a test sound in response to the test signal. The processor is further programmed to: process the measurement signal to predict a sound response at a second listening location adjacent to the first listening location, and adjust a sound setting associated with each low frequency transducer to optimize sound at the first listening location and at the second listening location.

In another embodiment, an audio system is provided with at least two low frequency transducers, wherein each of the at least two low frequency transducers is adapted to project sound within a room in response to receiving an audio signal. A controller is configured to: provide a test audio signal to each low frequency transducer in response to receiving a calibration command; process a measurement signal, indicative of the sound measured by at least two microphones at a first listening location within the room, to predict a sound response at a second listening location adjacent to the first listening location; and adjust a sound setting associated with each of the at least two low frequency transducers to optimize sound at the first listening location and at the second listening location.

In yet another embodiment an audio system is provided with at least two low frequency transducers, a portable device, and a controller. Each of the at least two low frequency transducers is adapted to project sound within a room in response to receiving an audio signal. The portable device includes at least two microphones to measure sound at a first listening location from multiple directions, and a microcontroller programmed to provide a calibration command in response to a user input, and to provide a measurement signal indicative of the sound measured by the at least two microphones. The controller is configured to: provide a first audio signal indicative of a predetermined sound sweep to each of the at least two low frequency transducers in response to receiving the calibration command, process the measurement signal to predict a sound response at a second listening location adjacent to the first listening location, adjust a sound setting associated with each of the at least two low frequency transducers to optimize sound at the first listening location and at the second listening location. The controller is further configured to receive a music signal, and provide a second audio signal indicative of the music signal and the adjusted sound settings to each of the at least two low frequency transducers.

### BRIEF DESCRIPTION OF THE DRAWINGS

FIG. 1 is a top view of an audio system including a portable measurement device according to one or more embodiments.

FIG. 2 is a system diagram of the audio system of FIG. 1.

FIG. 3 is a diagram illustrating three axial modes generated by one loudspeaker of the audio system of FIG. 1, illustrated with three listener locations relative to the loudspeaker.

FIG. 4A is a graph illustrating a magnitude response of sound generated by one loudspeaker of the audio system and measured at two listening locations within a room with no variation in the magnitude response between the two listening locations.

FIG. 4B is a graph illustrating a magnitude response of equalized sound generated by one loudspeaker of the audio system and measured at two listening locations within the room with no variation in the magnitude response between the two listening locations.

FIG. 5A is a graph illustrating a magnitude response of sound generated by one loudspeaker of the audio system and measured at two listening locations within a room with variation in the magnitude response between the two listening locations.

FIG. 5B is a graph illustrating a magnitude response of equalized sound generated by one loudspeaker of the audio system and measured at two listening locations within the room with variation in the magnitude response between the two listening locations.

FIG. 6 is a diagram illustrating three axial modes generated by two loudspeakers of the audio system of FIG. 1, illustrated with three listener locations relative to the loudspeakers.

FIG. 7 is a diagram illustrating a multi-subwoofer multi-receiver scenario in a room

FIG. 8 is a flow chart illustrating a method for automatically calibrating the audio system of FIG. 1.

FIG. 9 is a diagram illustrating the audio system of FIG. 1, including a first order microphone array, performing portions of the method of FIG. 8.

FIG. 10 is a diagram illustrating sound arriving at a listening location from all directions.

FIG. 11 is a diagram illustrating a simplification of the complex sound field of FIG. 10 into its orthogonal components.

FIG. 12 is a diagram illustrating an extrapolation of the sound components of FIG. 11 to predict the response at a new listening location.

FIG. 13 is a diagram illustrating the second order microphone array.

FIG. 14 is a graph of polar plots of sound measured by the second order microphone array of FIG. 13.

FIG. 15 is a diagram illustrating a three-dimensional model of the polar plots of FIG. 14.

FIG. 16 is a diagram illustrating a simplification of the complex sound field of FIG. 14 into its orthogonal components.

FIG. 17 is a graph illustrating a magnitude response of sound generated by the audio system of FIG. 1.

FIG. 17A is an enlarged view of a portion of the graph of FIG. 17.

FIG. 18 is a graph illustrating a phase response of predicted sound generated by the audio system of FIG. 1.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis.

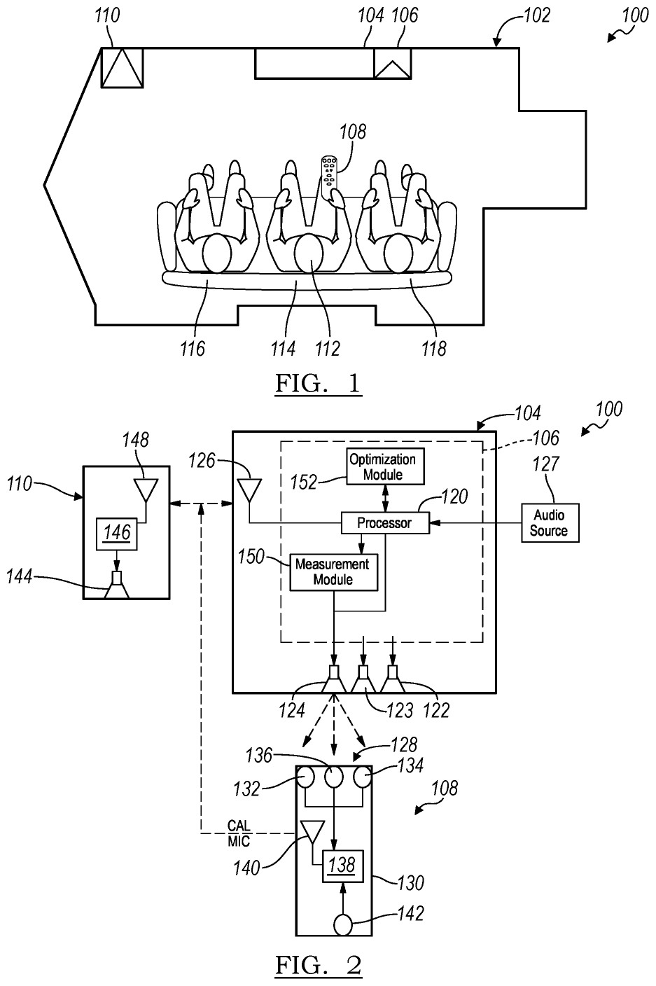

With reference to FIG. 1, an audio system is illustrated in accordance with one or more embodiments and generally referenced by numeral 100. The audio system 100 is depicted within a home listening environment, such as a room 102. The audio system 100 includes a loudspeaker, such as a soundbar 104 that includes one or more high frequency transducers, medium frequency transducers, and low frequency transducers (e.g., a subwoofer). The audio system 100 also includes a controller 106 and a portable measurement device 108. The audio system 100 may also include additional loudspeakers, such as an external subwoofer 110, that are mounted in a separate location of the room 102. A user 112 is illustrated holding the portable measurement device 108 at a first listening location 114, e.g., on a central seat of a couch. Adjacent to the user 112 are two additional listeners, one listener sitting at a second listening location 116 to the left of the user 112, and another listener sitting at a third listening location 118 to the right of the user 112. The audio system 100 automatically calibrates sound projected by the soundbar 104 and the external subwoofer 110 to multiple locations in the room 102, e.g., to the first, second, and third listening locations 114, 116, 118 in response to “one click” or command from the user 112 activating the portable measurement device 108 to take sound measurements at the first listening location 114.

Referring to FIG. 2, the soundbar 104 includes the controller 106, which includes a processor 120, such as a digital signal processor (DSP), and memory (not shown). The soundbar 104 includes a high frequency (HF) transducer 122, a medium frequency transducer 123, and a low frequency transducer, or subwoofer 124, according to one or more embodiments. In one or more embodiments, the subwoofer 124 provides sound between approximately 0-120 Hz, the medium frequency transducer 123 provides sound between approximately 120 Hz-2 kHz, and the high frequency (HF) transducer 122 provides sound between approximately 2 kHz-20 kHz. The soundbar 104 also includes a transceiver 126, e.g., a low power radio frequency (RF) transceiver, that is connected to the controller 106 for wirelessly communicating with other devices. The processor 120 receives an audio signal from an audio source 127, such as a television, media player, etc., and separates the audio signal into channels for each soundbar transducer 122, 123, and 124 and any additional transducers, e.g., the LF transducer 144 of the external subwoofer 110.

The portable measurement device 108 includes a microphone array 128 that is supported in a small housing 130, e.g., a handheld remote. The microphone array 128 is a first order array, including two microphones: a left microphone 132 and a right microphone 134, according to one embodiment. The left and right microphones 132, 134 are packaged relatively close to each other, e.g., approximately 10 cm apart, and arranged in opposite directions, e.g., left and right, to provide a directional sensor. Each microphone 132, 134, may be an omnidirectional microphone, such as the MM20-33366-B116 microphone by Knowles. In another embodiment, the microphone array 128 is a second order array, including three omnidirectional microphones: the left microphone 132, the right microphone 134 and a central microphone 136 that is centrally located between the left and right microphones 132, 134. Other embodiments of the audio system 100 include a microphone array 128 with a combination of different microphones, e.g., one or more acoustical cardioid microphones and one or more omnidirectional microphones, to make 2′ order or higher arrays with left and right facing lobes, and optionally, forward and backward facing lobes.

The portable measurement device 108 includes a microcontroller 138 and a transceiver 140, e.g., a low power radio frequency (RF) transceiver. The transceiver 140 is connected to the microcontroller 138 for wirelessly communicating with other devices, such as the soundbar 104. The portable measurement device 108 also includes an externally accessible button 142 that is in communication with the microcontroller 138 for initiating the automatic calibration sequence of the audio system 100. In one or more embodiments, some, or all, of the functionality of the portable measurement device 108 may be provided by a smartphone or tablet. For example, a smartphone may include a processor, a transceiver, and a touchscreen (button), like the microcontroller 138, transceiver 140, and button 142.

The external subwoofer 110 includes one or more low frequency transducers 144 and a subwoofer controller 146. The external subwoofer 110 also includes a transceiver 148, e.g., a low power radio frequency (RF) transceiver. The transceiver 148 is connected to the subwoofer controller 146 for wirelessly communicating with other devices, such as the soundbar 104 and the portable measurement device 108. In other embodiments the external subwoofer 110 communicates with the soundbar 104 by wired communication.

The controller 106 includes a measurement module 150 for controlling the calibration sequence. The controller 106 also includes an optimization module 152 for adjusting the parameters for each audio channel or transducer, such parameters include individual channel delays, gain, polarity, filters, etc. according to one or more embodiments.

Although the controller 106, the microcontroller 138, and the subwoofer controller 146 are each shown as a single controller, each may contain multiple controllers, or may be embodied as software code within one or more other controllers. The controllers 106, 138, 146 generally include any number of microprocessors, ASICs, ICs, memory (e.g., FLASH, ROM, RAM, EPROM and/or EEPROM) and software code to co-act with one another to perform a series of operations. Such hardware and/or software may be grouped together in modules to perform certain functions. Any one or more of the controllers or devices described herein include computer executable instructions that may be compiled or interpreted from computer programs created using a variety of programming languages and/or technologies. In general, a processor (such as a microprocessor) receives instructions, for example from a memory, a computer-readable medium, or the like, and executes the instructions. A processing unit includes a non-transitory computer-readable storage medium capable of executing instructions of a software program. The computer readable storage medium may be, but is not limited to, an electronic storage device, a magnetic storage device, an optical storage device, an electromagnetic storage device, a semi-conductor storage device, or any suitable combination thereof. The controllers 106, 138, 146, also include predetermined data, or “look up tables” that are stored within memory, according to one or more embodiments.

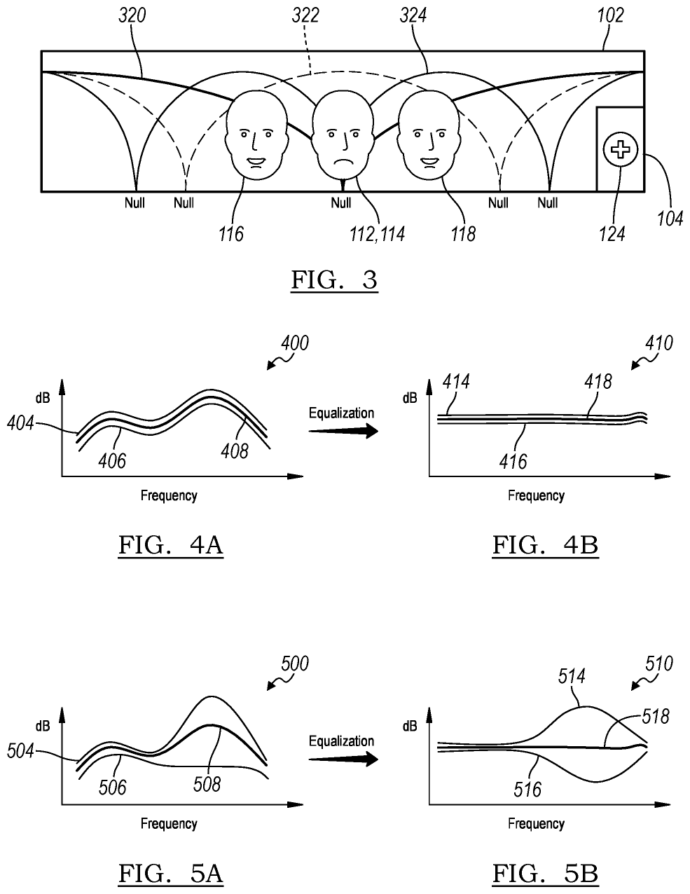

Referring to FIG. 3, the placement of subwoofers and listeners in small rooms and the size and shape of the room influence the resulting low frequency response. FIG. 3 illustrates what standing waves might look like in the room 102, with the soundbar 104 at one end. The subwoofer 124 of the soundbar 104 generates low frequency sound, and three of the lowest frequency standing sound waves are depicted as a first mode 320, a second mode 322, and a third mode 324, where each mode corresponds to a different frequency, e.g., 30 Hz, 60 Hz, and 90 Hz for one set of axial modes, respectively. FIG. 3 represents three axial modes for a single dimension of the room 102 for an instant in time. Sound pressure maxima exist at the room boundaries (i.e., the two ends of the room 102 in FIG. 2). The point where the sound pressure drops to its minimum value is commonly referred to as a “null.” If there is no mode damping, the sound pressure at the nulls drops to zero. However, in most real moms the response dip at the nulls is approximately −20 dB range.

Standing waves may have peaks and dips at different positions throughout the room so that large amplitude deviations may occur depending on where a listener is positioned. Thus, since the user 112 is positioned at a null for both the first mode 320 and the third mode 324, the sound produced by the subwoofer 124 at these frequencies will sound much softer than it should. Conversely, since the user 112 is positioned at the peak for the second mode 322, sound produced by the subwoofer 124 at this frequency will sound much louder than it should. The listeners at the second listening location 116 and at the third listening location 118 are not positioned at the null for any of the modes and therefore they will hear all three modes and have a more pleasant and accurate listening experience.

Referring to FIGS. 4A-4B, one approach to address standing wave issues with the single subwoofer scenario of FIG. 3, is to equalize the frequency response. FIG. 4A is a graph 400 with three curves 404, 406, 408 representing the frequency response of sound measurements generated by a single subwoofer within a room, e.g., the subwoofer 124 within the room 102 of FIG. 3, according to one embodiment. The first curve 404 represents the frequency response of sound measured at the first listening location 114. The second curve 406 represents the frequency response of sound measured at the second listening location 116. The third curve 408 represents the spatial average of the first curve 404 and the second curve 406. As illustrated in FIG. 4A, the first curve 404 and the second curve 406 rise and fall together at different frequencies, therefore there is little to no variation between the listening locations, or seat-to-seat variation, and the frequency response may be equalized to the desired target by applying an equalization filter to the parameters of the signal provided to each transducer.

FIG. 4B is a graph 410 including a first curve 414 that represents the equalized frequency response of the sound measured at the first listening location, a second curve 416 that represents the equalized frequency response of the sound measured at the second listening location, and a third curve 418 that illustrates the spatial average of the first curve 414 and the second curve 416. The first curve 414, the second curve 416, and the third curve 418 are all generally parallel with each other, which indicates that if there is no variation between the listening locations (as shown in FIG. 4A) the frequency response for both listening locations may be improved by equalizing the sound signal provided to the subwoofer 124.

With reference to FIGS. 5A-5B, the simple equalization approach of FIGS. 4A-4B, is not effective when there is seat-to-seat variation. FIG. 5A is a graph 500 with a first curve 504, a second curve 506, and a third curve 508 representing the frequency response of sound measurements generated by a single subwoofer within a mom, e.g., the subwoofer 124 within the room 102 of FIG. 3, according to another embodiment. The first curve 504 represents the frequency response of sound measured at the first listening location 114. The second curve 506 represents the frequency response of sound measured at the second listening location 116. The third curve 508 represents the spatial average of the first curve 504 and the second curve 506. The spatial average curve 508 is generally equal to the spatial average curve 408 of FIG. 4A. As illustrated in FIG. 5A, the first curve 504 and the second curve 506 do not rise and fall together through the frequency range, therefore there is variation between the listening locations.

FIG. 5B is a graph 510 including a first curve 514 that represents the equalized frequency response of the sound measured at the first listening location 114, a second curve 516 that represents the equalized frequency response of the sound measured at the second listening location 116, and a third curve 518 that illustrates the spatial average of the first curve 514 and the second curve 516. Although the spatial average curves 408, 508 are generally equal to each other, the equalized curves 514 and 516 diverge from each other, which indicates that if there is variation between the listening locations (as shown in FIG. 5A) such an equalization approach is not effective. Having variation between the listening locations in the frequency response means that fixing the sound at one location with a simple equalizer may adversely affect the sound at another location.

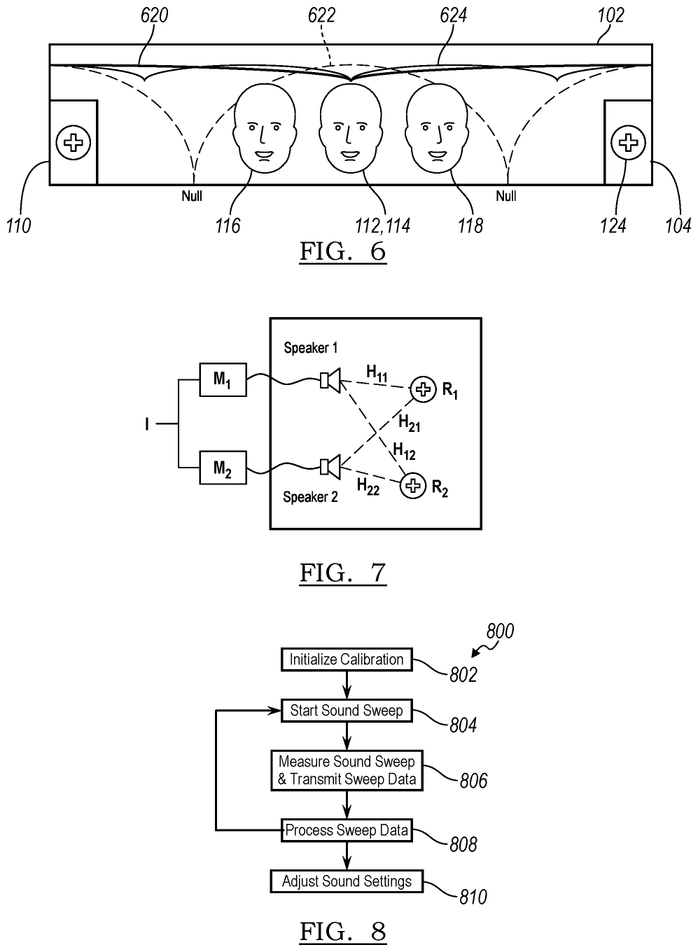

With reference to FIG. 6, another approach to address variation between the listening locations of sound quality is to use multiple subwoofers at different locations, because subwoofers at different locations in the room 102 can partially cancel certain standing waves. FIG. 6 illustrates the room 102 with both the subwoofer 124 of the soundbar 104 and the external subwoofer 110 generating the low frequency modes from different locations, which cancels two of the three modes, i.e., the first mode 620 and the third mode 624, but not the second mode 622, at the first listening location 114. However, this approach requires additional loudspeakers, e.g., the external subwoofer 110, and there are still nulls present in the room 102 that are adjacent to the second and third listening locations 116, 118.

FIG. 7 is a diagram illustrating an example of a multi-subwoofer multi-receiver scenario in a room. Reference I is the input audio signal to the audio system 100. The loudspeaker/room transfer functions from the subwoofer 124 of the soundbar 104 (Speaker 1) and the external subwoofer 110 (Speaker 2) to two receiver locations (e.g., the first listening location 114, and the second listening location 116) in the room 102 are represented by H₁₁, H₁₂, H₂₁, and H₂₂, while R₁ and R₂ represent the resulting transfer functions at the receiver (listening) locations. Each source has a transmission path to each receiver, resulting in four transfer functions in this example. Assuming the signal sent to each loudspeaker can be electrically modified, represented by M₁ and M₂, the modified signals may be added. Here, M is a complex modifier that may or may not be frequency dependent. To illustrate the complexity of the mathematical solution, the following equations solve a linear time invariant system in the frequency domain:

R₁(f)=IH₁₁(f)M₁(f)+IH₂₁(f)M₂(f)

R₂(f)=IH₁₂(f)M₁(f)+IH₂₂(f)M₂(f)(f)

where all transfer functions and modifiers are understood to be complex. This is recognized as a set of simultaneous linear equations, and can be more compactly represented in matrix form as:

$$[ \begin{matrix}{H}_{11} & {H}_{21} \\ {H}_{12} & {H}_{22}\end{matrix} ] [ \begin{matrix}{M}_{1} \\ {M}_{2}\end{matrix} ] = [ \begin{matrix}{R}_{1} \\ {R}_{2}\end{matrix} ] \qquad ( 2 )$$

or simply,

HM=R, (3)

where the input I has been assumed to be unity.

A typical goal for optimization is to have R equal unity, i.e., the signal at all receivers is identical to each other. R may be viewed as a target function, where R₁ and R₂ are both equal to 1. Solving equation (3) for M (the modifiers for the audio system), M=H⁻¹, the inverse of H. Since H is frequency dependent, the solution for M is calculated at each frequency. The values in H, however, may be such that an inverse may be difficult to calculate or unrealistic to implement (such as unrealistically high gains for some loudspeakers at some frequencies).

As an exact mathematical solution is not always feasible to determine, prior approaches have attempted to determine the best solution calculable, such as the solution with the smallest error. The error function defines how close any particular configuration is to the desired solution, with the lowest error representing the best solution. However, this mathematical methodology requires significant computational energy, yet only solves for a two-parameter solution. Acoustical problems that examine a greater number of parameters are increasingly difficult to solve. Some audio systems have attempted to solve the problem by analyzing sound measurements taken at many different locations within in a listening room, however such an approach may be difficult for an end-user in a home listening environment.

With reference to FIG. 8, and referring back to FIG. 2, a method for automatically calibrating the audio system 100 is illustrated in accordance with one or more embodiments and generally referenced by numeral 800. The method 800 is implemented using software code contained within the controller 106 according to one or more embodiments. While the method is described using flowcharts that are illustrated with a number of sequential steps, one or more steps may be omitted and/or executed in another manner in one or more other embodiments. In other embodiments, the software code is distributed among multiple controllers, e.g., the controller 106 and the microcontroller 138.

At step 802, a user 112 initializes the calibration sequence by pressing the button 142 on the portable measurement device 108 while seated at the first listening location 114. In other embodiments, the calibration procedure may be initialized in response to a voice command, or by signaling using a smartphone or tablet. The microcontroller 138, of the portable measurement device 108, generates an initialization command (CAL) and transmits the initialization command to the soundbar 104 via the transceiver 140.

At step 804, the controller 106 receives the initialization command via the transceiver 126, and the processor 120 activates the measurement module 150 to provide a sound sweep signal to the subwoofer 124 to emit as sound. In one embodiment, the sound sweep corresponds to sound that varies in amplitude from −60 to 60 dB and varies in frequency from 0 to 150 Hz. At step 806, the microphone array 128 of the portable measurement device 108 measures the sound sweep at the first listening location 114 and transmits the sweep data (MIC) to the soundbar 104.

At step 808 the controller 106 processes the sweep data to predict the response at other listening locations, e.g., the second listening location 116, and the third listening location 118. The processor 120 may provide the predicted responses to the optimization module 152, which uses an optimization algorithm, such as a Sound Field Management algorithm as described in U.S. Pat. No. 7,526,093 to Devantier et. al, which is incorporated by reference in its entirety herein, to further process the data. In one or more embodiments, the controller 106 may employ other techniques or algorithms to increase the signal-to-noise ratio, such as conducting multiple sweeps and repeating steps 804-808, or sampling the background noise and tailoring the stimulus to put more energy into the frequencies where there is more noise. Then at step 810, the controller 106 adjusts the sound settings, e.g., the parameters for each individual channel including the time delay, gain, polarity and filter coefficients, based on the predicted responses.

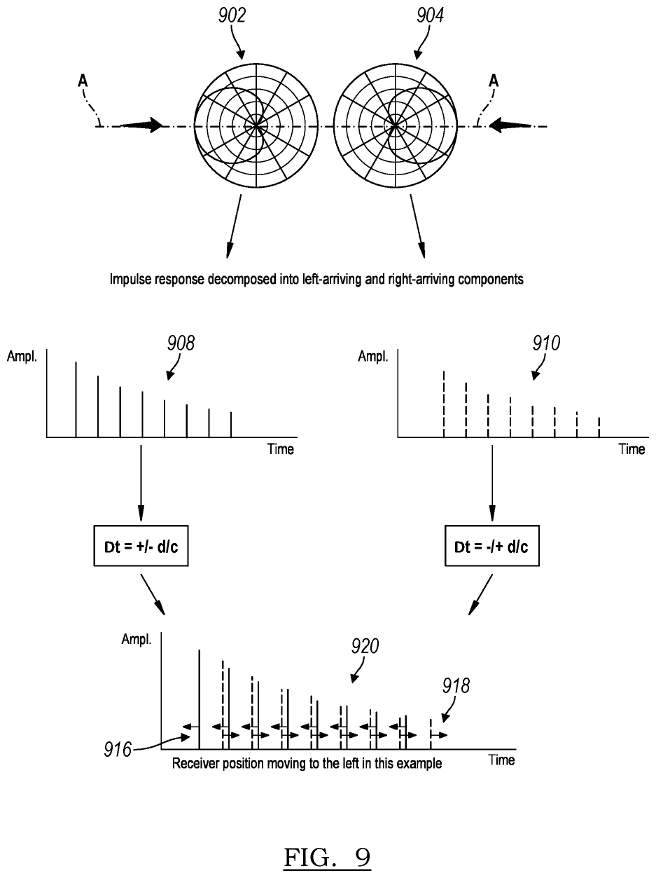

FIG. 9 illustrates an embodiment of the audio system 100, including a first order microphone array, performing the automatic calibration method 800. Referring to FIG. 9, and with reference back to FIG. 1, the microphone array 128 is a first order array including the left microphone 132 and the right microphone 134 according to one or more embodiments. The sound provided by the audio system 100 reflects off of surfaces within the room 102, which resembles sound provided by multiple virtual sources of sound, located at corresponding positions outside the room. The acoustical response at the first listening location 114 in the room 102 is the same as what would occur with no room and a cloud of such virtual sources. When the user 112 moves from the first listening location 114 to the second listening location 116, the user 112 is approximately one meter closer to the virtual images directly on the left, i.e. the distance between the centers of adjacent cushions on a couch, and one meter further from the virtual images directly on the right. For virtual sources directly in front or behind the user, there would be minimal or no change in distance. For virtual sources at any other direction, there would be an intermediate difference in distance to virtual sources.

FIG. 9 illustrates how the left arriving and right arriving sound could be measured at step 806 using directional microphones 132, 134, and processed at step 808 by shifting the impulse response based on the estimated distances between listening locations, then recombined. At step 806, the portable measurement device 108 measures the sound sweep using the first order microphone array 128. The microphone array 128 is configured as a directional microphone with the left and right microphones 132, 134 arranged along an Axis A-A in opposite directions at close spacing, e.g., approximately 10 cm apart. FIG. 9 includes a left polar plot 902 that represents sound measured by the left microphone 132, and a right polar plot 904 that represents the sound measured by the right microphone 134. The left and right microphones 132, 134 are cardioid microphones in the illustrated embodiment, which attenuate sound arriving from off-axis directions.

At step 808, the controller 106 of the soundbar 104 processes the sound sweep data. The processor 120 includes an accurate signal delay element and a gain element for each microphone 132, 134. The processor 120 decomposes the sound received at each microphone 132, 134 of the microphone array 128 into left arriving and right arriving components, as depicted by a left reflectogram 908 and a right reflectogram 910. Sound received directly from the soundbar 104 will be received by a front lobe and a rear lobe (not shown) of the microphone array 128, and not shifted in time.

The measurement module 150 can predict the sound present at different listening locations, e.g., the second listening location 116, and the third listening location 118, by adjusting the sound settings at step 810 by shifting the time delay associated with the sound measured at the left microphone 132 (Δt_{L}) and the sound measured at the right microphone 134 (Δt_{R}) according to equations 4 and 5 as shown below:

Δt_{L}=+/−d/c (4)

Δt_{R}=−/+d/c (5)

where (d) represents the distance between listening locations, e.g., one meter, (c) represents the speed of sound, (−) is used for predicting sound at a location in the same direction as the microphone (e.g., at a location to the left of the left microphone 132), and (+) is used for predicting sound at a location in the opposite direction as the microphone (e.g., at a location to the right of the left microphone 132). For example, the audio system 100 predicts the sound at the second listening location 116, which is oriented to the left of the first listening location 114, by subtracting d/c from each impulse measured by the left microphone 132, as referenced by numeral 916, and adding d/c to each impulse measured by the right microphone 134, as referenced by numeral 918. The audio system 100 then recombines the shifted signals, which are represented by the simplified reflectograms, as generally referenced by numeral 920.

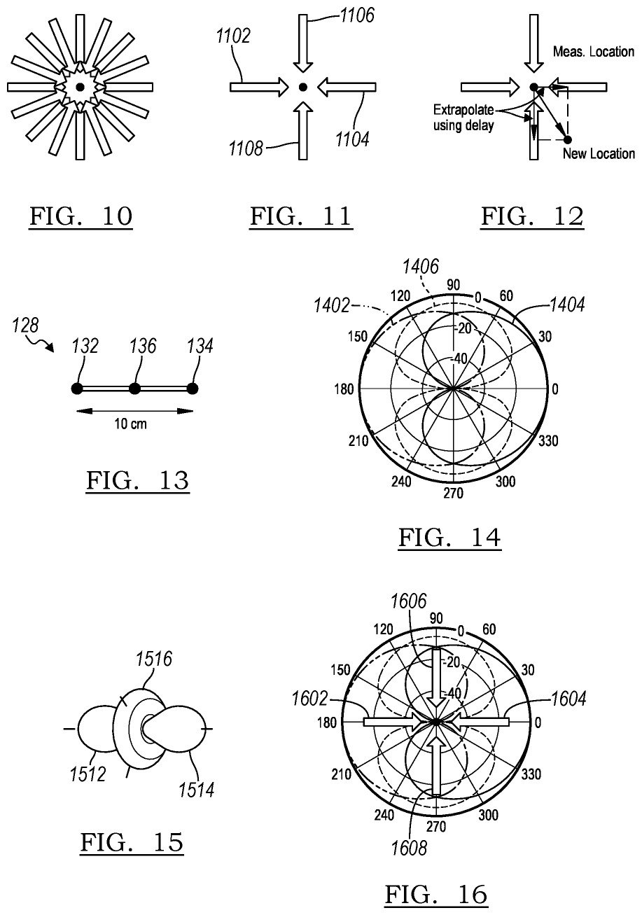

FIGS. 10-16 illustrate portions of the automatic calibration method 800 performed by an embodiment of the audio system 100 that includes a second order microphone array. The microphone array 128 is a second order array including the left microphone 132, the right microphone 134, and the central microphone 136 according to one or more embodiments. FIGS. 10-12 illustrate the basic theory behind the method 800 for automatically calibrating the audio system as described with reference to FIG. 8, by decomposing a complex sound field and subsequently extrapolating the sound to predict the response at a new location.

Referring to FIG. 10, at any point in space, e.g., at the first listening location 114, sound arrives from all directions, as depicted by the converging arrows. With reference to FIG. 11 the audio system 100 utilizes a second order microphone array 128 to simplify the complex sound field of FIG. 10 into its orthogonal components: a left sound component 1102, a right sound component 1104, an forward sound component 1106, and a rearward sound component 1108. Then with reference to FIG. 12, the audio system 100 subsequently extrapolates the sound to predict the response at a new location by adding delays to components and summing the components.

FIGS. 13-15 illustrate how the audio system 100 uses array directivity to separate out the directional components for left, right, and forward/backward directions. FIG. 13 illustrates the second order microphone array 128 including: the left microphone 132, the right microphone 134, and the central microphone 136.

FIG. 14 illustrates overlaid polar plots of the sound measured by each microphone. The polar plots include: a left polar plot 1402 that represents the sound measured by the left microphone 132, a right polar plot 1404 that represents the sound measured by the right microphone 134, and a medial polar plot 1406 that represents the sound measured by the central microphone 136. The left and right microphones 132, 134 are cardioid microphones according to the illustrated embodiment, which attenuate off-axis arriving sound. However, the central microphone 136 is an omnidirectional microphone which measures sound in all directions. The medial polar plot 1406 is generated by subtracting the sound data measured by the left microphone 132 and right microphone 134 from the sound data generated by the central microphone 136. The audio system 100 performs this subtraction so that the combined directivity data from the microphones 132, 134, 136 sums to zero.

FIG. 15 illustrates a three-dimensional (3D) diagram of the of the polar plots. The 3D diagram includes a left cardioid element 1512 that represents the left polar plot 1402, a right cardioid element 1514 that represents the right polar plot 1404, and a medial element 1516 that represents the medial polar plot 1406.

With reference to FIG. 16, the audio system 100 processes the sweep data at step 808 by simplifying the complex sound field of FIGS. 13-15 into its orthogonal components: a left sound component 1602, a right sound component 1604, a forward sound component 1606, and a rearward sound component 1608. Then the audio system 100 subsequently extrapolates the sound components 1602, 1604, 1606, 1608 to predict the response at a new location by adding delays to components and summing the components

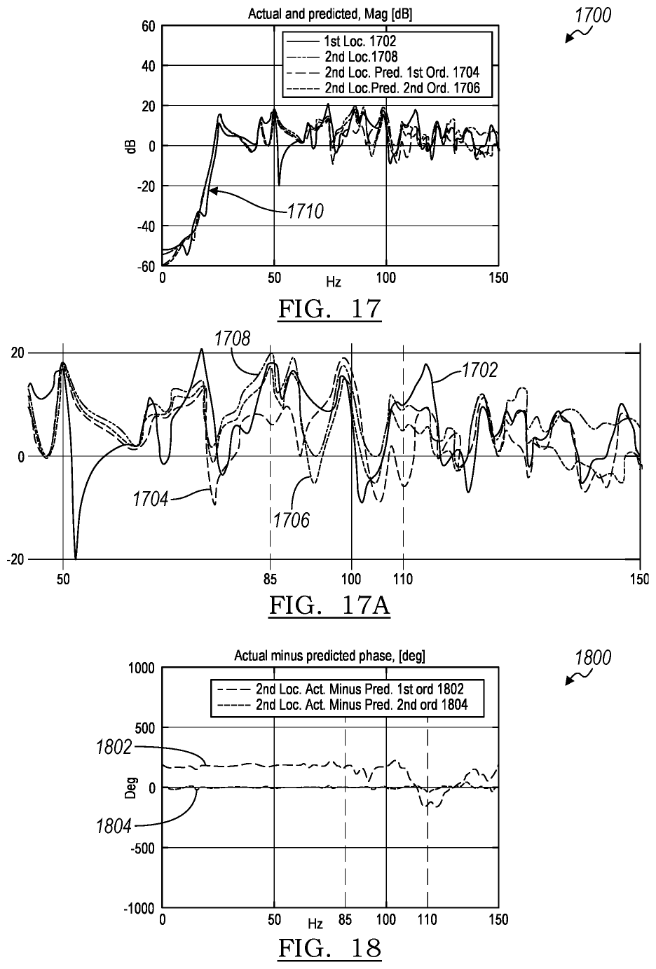

FIGS. 17-18 illustrate a comparison of the performance of the audio system 100 with a first order microphone array to the audio system 100 with a second order microphone array when performing the automatic calibration method 800. FIG. 17 is a graph 1700 including four curves 1702, 1704, 1706, and 1708 illustrating a magnitude response of the audio system 100, and FIG. 17A is an enlarged view of the graph 1700 between −20 and 20 dB and 50 and 150 Hz.

The first curve 1702 represents the actual sound present at the first listening location 114. The second curve 1704 represents the sound predicted at the second listening location 116 by the audio system 100 based on sensor data taken from a first order microphone array, including the left microphone 132 and the right microphone 134, as described above with reference to FIG. 9. The third curve 1706 represents the sound predicted at the second listening location 116 by the audio system 100 based on sensor data taken from a second order microphone array, including the left microphone 132, the right microphone 134, and the central microphone 136, as described above with reference to FIGS. 10-16. The fourth curve 1708 represents the actual sound present at the second listening location.

A comparison of the second curve 1704 (first order array) and third curve 1706 (second order array) to the fourth curve 1708 illustrate the improved performance of the second order array over the first order array. For example, at 85 Hz, the second order curve 1706 differs from the actual sound curve 1708 by approximately 2 dB, whereas the first order curve 1704 differs from the actual sound curve by approximately 12 dB. Similarly, at 110 Hz, the second order curve 1706 differs from the actual sound curve 1708 by approximately 4 dB, whereas the first order curve 1704 differs from the actual sound curve by approximately 14 dB. At both locations, the second order array provides an improvement of approximately 10 dB over the first order array.

The magnitude response drops off at low frequencies, e.g., below 25 Hz, as referenced by numeral 1710 in FIG. 13. This drop-off depends on the spacing of the microphones since their ability to differentiate sound having large wavelengths depends on having sufficient spacing themselves. The audio system 100 includes a 6 dB per octave correction for first order systems, and 12 dB for the second order system to compensate for the drop-off.

FIG. 18 is a graph 1800 including two curves 1802 and 1804 illustrating a phase response of the audio system 100. The first curve 1802 represents a difference between the actual sound at the second listening location 116 and the sound predicted at the second listening location 116 by the audio system 100 using the first order microphone array. The second curve 1804 represents a difference between the actual sound at the second listening location 116 and the sound predicted at the second listening location 116 by the audio system 100 using the second order microphone array. The first curve 1802 varies significantly through the frequency range of 0 to 150 Hz. For example, the first curve is equal to approximately 200 degrees 85 Hz, and equal to approximately −200 degrees at 110 Hz. Whereas the second curve 1804 is approximately equal to zero throughout the frequency range, which indicates that the phase response of the second order system is much better than the first order system.

The automatic calibration method 800 can be expanded to allow similar sound prediction in directions other than left/right by using a third-order microphone array (i.e., four microphones) having a 3D arrangement of microphones. A 3D arrangement may predict the response anywhere in the vicinity of a listening location, including up and down to accommodate a room 102 having seating at different vertical positions, e.g., stadium seating. Although the method 800 is described as a time domain approach, the same calculations may be performed in the frequency domain.

The method 800 does not make any assumptions about the acoustical environment based on extensive predetermined data, nor does it rely on complex room modelling or machine learning methods or the like. Rather the method 800 utilizes the acoustical field in the room as measured by the microphone array 128. Therefore, the audio system 100 does not require extensive installation, e.g., many initial measurements, which allows a user 112 to calibrate the system.

While exemplary embodiments are described above, it is not intended that these embodiments describe all possible forms of the present disclosure. Rather, the words used in the specification are words of description rather than limitation, and it is understood that various changes may be made without departing from the spirit and scope of the present disclosure. Additionally, the features of various implementing embodiments may be combined to form further embodiments.

What is claimed is:

1. An audio system comprising:
at least two low frequency transducers to project sound within a room;
a portable device comprising:
a microphone array comprising at least two microphones to receive sound generated by each of the at least two low frequency transducers at a first listening location from multiple directions, and
a microcontroller programmed to provide a calibration command in response to a user input and to provide a measurement signal indicative of the sound received by the microphone array; and
a processor programmed to:
provide a test signal in response to receiving the calibration command, wherein each of the at least two low frequency transducers is adapted to generate a test sound in response to the test signal,
process the measurement signal to predict a sound response at a second listening location adjacent to the first listening location, and
adjust a sound setting associated with each of the at least two low frequency transducers to optimize sound at the first listening location and at the second listening location.

2. The audio system of claim 1, wherein each of the at least two low frequency transducers is adapted to generate test sound below 120 Hertz in response to the test signal.

3. The audio system of claim 1, wherein the at least two microphones further comprise:
a first microphone disposed on an axis and arranged in a first direction to receive incoming sound and attenuate off-axis incoming sound; and
a second microphone disposed on the axis and arranged in a second direction, opposite the first direction, to receive incoming sound and attenuate off-axis incoming sound.

4. The audio system of claim 3, wherein the processor is further programmed to process the measurement signal to predict the sound response at the second listening location adjacent to the first listening location by shilling a time delay associated with the sound received at each of the first microphone and the second microphone based on a distance between the first listening location and the second listening location.

5. The audio system of claim 3, wherein the microphone array further comprises a third microphone disposed on the axis between the first microphone and the second microphone to receive sound from multiple directions.

6. The audio system of claim 5, wherein the microcontroller of the portable device is further programmed to:
determine a combined sound directivity based on a difference between the sound received by the first and second microphones and the sound received by the third microphone; and
provide the measurement signal based on the combined sound directivity.

7. The audio system of claim 1, wherein the processor is further programmed to:
separate the measurement signal into orthogonal components; and
extrapolate the orthogonal components to the second listening location.

8. The audio system of claim 1, wherein the test signal is indicative of a predetermined sound sweep.

9. The audio system of claim 1, wherein the processor is further programmed to provide an audio signal indicative of a music signal and the adjusted sound settings to each of the at least two low frequency transducers.

10. The audio system of claim 1, wherein the portable device further comprises an externally accessible button, and wherein the microcontroller of the portable device is further programmed to provide the calibration command in response to a user pressing the externally accessible button.

11. An audio system comprising:
at least two low frequency transducers, wherein each of the at least two low frequency transducers is adapted to project sound within a room in response to receiving an audio signal; and
a controller configured to:
provide a test signal to each of the at least two low frequency transducers in response to receiving a calibration command;
process a measurement signal, indicative of the sound received by at least two microphones at a first listening location within the room, to predict a sound response at a second listening location adjacent to the first listening location; and
adjust a sound setting associated with each of the at least two low frequency transducers to optimize sound at the first listening location and at the second listening location.

12. The audio system of claim 11, wherein the controller is further configured to:
separate the measurement signal into orthogonal components; and
extrapolate the orthogonal components to the second listening location.

13. The audio system of claim 11, wherein the test signal is indicative of a predetermined sound sweep.

14. The audio system of claim 11, wherein the controller is further configured to provide an audio signal indicative of a music signal and the adjusted sound settings to each of the at least two low frequency transducers.

15. The audio system of claim 11, further comprising:
a portable device with a microcontroller coupled to the at least two microphones and configured to provide the measurement signal indicative of the sound received by the at least two microphones; and
wherein the at least two microphones comprise:
a first microphone disposed on an axis and arranged in a first direction to receive incoming sound and attenuate off-axis incoming sound, and
a second microphone disposed on the axis and arranged in a second direction, opposite the first direction, to receive incoming sound and attenuate off-axis incoming sound.

16. The audio system of claim 15, wherein the controller is further configured to process the measurement signal to predict the sound response at the second listening location adjacent to the first listening location by shifting a time delay associated with the sound received at each of the first microphone and the second microphone based on a distance between the first listening location and the second listening location.

17. The audio system of claim 15, further comprising a third microphone disposed on the axis between the first microphone and the second microphone to receive sound from multiple directions.

18. The audio system of claim 17, wherein the microcontroller of the portable device is further configured to:
determine a combined sound directivity based on a difference between the sound received by the first and second microphones and the sound received by the third microphone; and
provide the measurement signal based on the combined sound directivity.

19. An audio system comprising:
at least two low frequency transducers, wherein each of the at least two low frequency transducers is adapted to project sound within a room in response to receiving an audio signal;
a portable device comprising:
at least three microphones adapted to receive sound at a first listening location, and
a microcontroller configured to provide a calibration command in response to a user input, and to provide a measurement signal indicative of the sound received by the at least three microphones; and
a controller configured to:
provide a first audio signal indicative of a predetermined sound sweep to each of the at least two low frequency transducers in response to receiving the calibration command,
process the measurement signal to predict a sound response at a second listening location adjacent to the first listening location,
adjust a sound setting associated with each of the at least two low frequency transducers to optimize sound at the first listening location and at the second listening location,
receive a music signal, and
provide a second audio signal indicative of the music signal and the adjusted sound settings to each of the at least two low frequency transducers.

20. The audio system of claim 19, wherein the at least three microphones comprise:
a first microphone disposed on an axis and arranged in a first direction to receive incoming sound and attenuate off-axis incoming sound, and
a second microphone disposed on the axis and arranged in a second direction, opposite the first direction, to receive incoming sound and attenuate off-axis incoming sound.
a third microphone disposed on the axis between the first microphone and the second microphone to receive sound from multiple directions.
wherein the microcontroller of the portable device is further configured to:
determine a combined sound directivity based on a difference between the sound received by the first and second microphones and the sound received by the third microphone; and
provide the measurement signal based on the combined sound directivity.
